(19) United States
(12) Patent Application Publication
(10) Pub. No.: US 2015/0189452 A1
(43) Pub. Date: Jul. 2, 2015

(54) MULTIPLE INPUT PERSONAL AUDIO ENHANCEMENT DEVICE

(71) Applicants: Wah Leung CHAN, Kowloon (HK); Karl WIKLUND, Hamilton (CA)

(72) Inventors: Wah Leung CHAN, Kowloon (HK); Karl WIKLUND, Hamilton (CA)

(21) Appl. No.: 14/144,063

(22) Filed: Dec. 30, 2013

(51) Int. Cl. H04R 25/00

(52) U.S. Cl. CPC H04R 25/554; H04R 2225/51; H04R 2225/43

(57) ABSTRACT

A handheld multiple-input personal audio enhancement device comprises a device power source, a signal processor coupled to the device power source, a first bidirectional audio connector port coupled to the signal processor and a second bidirectional audio connector port coupled to the signal processor. The personal audio enhancement device may also include a wireless receiver antenna coupled to the signal processor for receiving wireless signals, and the signal processor may include a frequency-selective amplifier. A control interface may be coupled to the signal processor for selecting among a plurality of audio modes, including a wireless audio mode for listening to audio from a wireless audio signal, an ambient mode for listening to conversations, and an interconnect mode for using a telephone or other audio device. A predefined audio mode for listening to predefined audio signals may also be provided.

### TECHNICAL FIELD

The present disclosure relates to personal audio enhancement devices, and more particularly to personal audio enhancement devices worn or carried externally of the ear and earlobe.

### BACKGROUND

Hearing loss is a fairly common ailment, especially as people age. People with hearing impairment may encounter a variety of different situations in which their hearing loss interferes with their daily lives. For example, in social situations it may be difficult for a person with hearing loss to hear what his or her conversation partner is saying, especially in a noisy environment. Talking on the telephone may also be difficult for a person with hearing loss, especially where the telephone is a mobile radio telephone (commonly known as a cellular phone or “cell phone”), since these devices are often used in settings where there is significant ambient noise. Enjoying entertainment, such as television and radio, or even listening to personal entertainment devices like MP3 players, can also pose a problem for a person with hearing loss.

To alleviate some of the effects of hearing loss, a wide variety of hearing aids are available, and many of these work quite well in specific situations. However, a hearing aid which performs well in one situation may underperform in another.

### SUMMARY

A handheld, multiple-input personal audio enhancement device can be used in a variety of situations, including while watching television, during social interactions, or while on the phone. The small size of the personal audio enhancement device enables it be held in the hand, placed in a pocket or on a belt so that it is portable and accessible to a person.

In one embodiment, a handheld multiple-input personal audio enhancement device comprises a device power source, a signal processor coupled to the power source, a first bidirectional audio connector port coupled to the signal processor and a second bidirectional audio connector port coupled to the signal processor.

In a preferred embodiment, the personal audio enhancement device further comprises a wireless receiver antenna coupled to the signal processor for receiving wireless signals.

Also in a preferred embodiment, the signal processor includes a frequency-selective amplifier.

Preferably, the personal audio enhancement device comprises a control interface coupled to the signal processor for selecting among a plurality of audio modes. In a preferred embodiment, the control interface enables selection among a wireless signal mode, an ambient mode and an interconnect mode. In the wireless signal mode, the signal processor converts a wireless signal received by the wireless receiver antenna into a wireless signal mode audio signal, amplifies selected frequencies of the wireless signal mode audio signal to obtain a wireless signal mode amplified audio signal, and delivers the wireless signal mode amplified audio signal to an audio output channel of the first bidirectional audio connector port. In the ambient mode, the signal processor receives an ambient mode audio signal from an audio input channel of the first bidirectional audio connector port, amplifies selected frequencies of the ambient mode audio signal to obtain an ambient mode amplified audio signal, and delivers the ambient mode amplified audio signal to the audio output channel of the first bidirectional audio connector port. In the interconnect mode, the signal processor receives an interconnect mode first audio signal from an audio input channel of the second bidirectional audio connector port, amplifies selected frequencies of the interconnect mode first audio signal to obtain an interconnect mode first amplified audio signal, and delivers the interconnect mode first amplified audio signal to the audio output channel of the first bidirectional audio connector port. Preferably, in the interconnect mode, the signal processor also receives an interconnect mode second audio signal from the audio input channel of the first bidirectional audio connector port and delivers the interconnect mode second audio signal to an audio output channel of the second bidirectional audio connector port.

In a preferred embodiment, the control interface also enables selection of a predefined audio mode in which the signal processor delivers predefined audio signals to the audio output channel of the first bidirectional audio connector port.

The personal audio enhancement device may form part of a personal audio enhancement system which further comprises a transmitter station. The transmitter station comprises a transmitter power source, a transmitter audio connector port for receiving at least an audio input signal, a wireless transmitter antenna and a transmitter circuit coupled to the power source, the transmitter audio connector port and the wireless transmitter antenna for converting the audio signal to a wireless signal and delivering the wireless signal to the antenna for broadcast on a frequency to which the wireless receiver antenna is tuned.

In a preferred embodiment, the device power source is at least one rechargeable battery and the personal audio enhancement device exposes recharging terminals coupled to the rechargeable battery or batteries for recharging thereof and the transmitter station includes at least one docking port for receiving the audio enhancement device. Each docking port exposes power supply terminals aligned with the recharging terminals when the audio enhancement device is received at the docking port, with the power supply terminals being coupled to the transmitter power source. In one embodiment, the transmitter station includes two docking ports.

In certain embodiments, the personal audio enhancement device may form part of a personal entertainment device or part of a mobile radio telephone.

In a preferred embodiment, the personal audio enhancement device further comprises a housing carrying the device power source, the signal processor, the first bidirectional audio connector port and the second bidirectional audio connector port, with the first bidirectional audio connector port and the second bidirectional audio connector port being exposed to receive respective connectors.

The housing preferably has dimensions smaller than 200 millimeters long by 120 millimeters wide by 40 millimeters thick, more preferably has dimensions smaller than 150 millimeters long by 90 millimeters wide by 30 millimeters thick, and still more preferably has dimensions smaller than 120 millimeters long by 72 millimeters wide by 24 millimeters thick.

In one embodiment, a kit of parts may comprise an audio enhancement device as described above and a housing for assembly by a consumer.

A method of using a handheld multiple-input personal audio enhancement device comprises providing a handheld multiple-input audio enhancement device as described above and including a wireless receiver antenna coupled to the signal processor for receiving wireless signals as well as a control interface coupled to the signal processor for selecting among a plurality of audio modes. The method further comprises using the control interface to select among the wireless signal mode, the ambient mode and the interconnect mode. Preferably, the method also enables selection of the predefined audio mode.

### BRIEF DESCRIPTION OF THE DRAWINGS

These and other features will become more apparent from the following description in which reference is made to the appended drawings wherein:

FIG. 1 is a schematic representation of an exemplary personal audio enhancement system;

FIG. 2 is a schematic representation of signal processing by a personal audio enhancement device in an exemplary wireless signal mode;

FIG. 3 is a schematic representation of signal processing by a personal audio enhancement device in an exemplary ambient mode;

FIG. 4 is a schematic representation of signal processing by a personal audio enhancement device in an exemplary interconnect mode;

FIG. 5 is a schematic representation of signal processing by a personal audio enhancement device in an exemplary predefined audio mode;

FIG. 6 is a flow chart showing a method of using a handheld multiple-input personal audio enhancement device;

FIG. 7 shows a personal entertainment device which includes a personal audio enhancement device; and

FIG. 8 shows a mobile radio telephone which includes a personal audio enhancement device.

### DETAILED DESCRIPTION

The embodiments of the personal audio enhancement device described below have two bidirectional audio connector ports to enable simultaneous connection between an external audio source and the personal audio enhancement device and between the personal audio enhancement device and an earphone and microphone system.

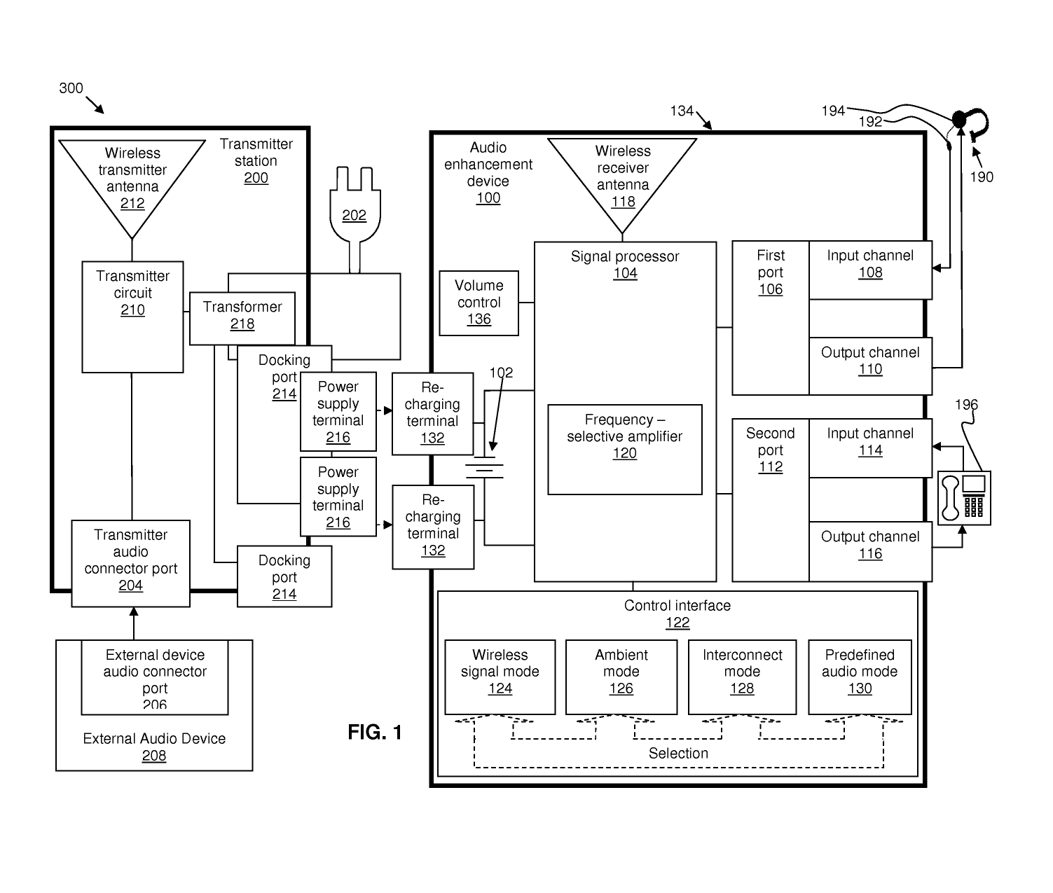

FIG. 1 shows a schematic representation of an exemplary personal audio enhancement system 300 comprising an exemplary personal audio enhancement device 100 and an exemplary transmitter station 200. The personal audio enhancement device 100 comprises a device power source 102 and a signal processor 104 including a frequency-selective amplifier 120. The personal audio enhancement device 100 further comprises first and second bidirectional audio connector ports 106 and 112, a wireless receiver antenna 118, a control interface 122 and a volume control 136 all coupled to the signal processor 104. The signal processor 104 is coupled to the device power source 102; the connection may be direct or indirect and the device power source 102 may also be connected to other components. A direct connection between the device power source 102 and the signal processor 104 is shown in the Figures simply for ease of illustration. The personal audio enhancement device 100 is preferably encased in a housing 134 where the housing 134 maintains the relative positions of the various components of the audio enhancement device 100 while exposing the bidirectional audio connector ports 106 and 112 for connection to external audio hardware. In a preferred embodiment, the bidirectional audio connector ports 106 and 112 are both standard 3.5 mm three conductor (TRS) or four conductor (TRRS) input sockets providing mono (TRS) or stereo (TRRS) sound output and sound input, although other suitable bidirectional audio connector ports may also be used. If a rechargeable battery 102 is used as a power source for the audio enhancement device 100, recharging terminals 132 are also exposed by the housing 134, as will be described in greater detail below.

The housing 134 not only functionally maintains the relative positions of the various components, it can aesthetically modify the appearance of the personal device to suit the preferences of the user. In some embodiments, the housing 134 may be of different shapes, colors, textures, or some other combination thereof providing to the user a personalized audio enhancement device. Preferably, the housing is shaped to resemble a handheld personal device such as a mobile telephone or music player. The housing 134 preferably has dimensions smaller than 200 millimeters long by 120 millimeters wide by 40 millimeters thick, more preferably has dimensions smaller than 150 millimeters long by 90 millimeters wide by 30 millimeters thick, and still more preferably has dimensions smaller than 120 millimeters long by 72 millimeters wide by 24 millimeters thick. In one embodiment, a kit of parts may comprise an audio enhancement device 100 and a housing 134 for assembly by a consumer.

The exemplary handheld multiple-input personal audio enhancement device 100 can be used in different situations, such as watching television, communicating via the telephone, during social events, or to listen to preloaded audio sounds.

In addition to the personal audio enhancement device 100, the personal audio enhancement system 300 comprises a transmitter station 200 which is powered by a transmitter power source 202, such as connection to a conventional electrical socket. The transmitter station 200 includes a transmitter audio connector port 204, which can receive an audio input signal directly from an external audio device 208 via an external device audio connector port 206 thereof. Suitable conventional audio connection sockets may be used for the transmitter audio connector port 204 and the external device audio connector port 206, which may be connected by a wire with suitable connectors at either end. The external audio device 208 may be, for example, a television, a radio, a music player, or other entertainment system. The transmitter station 200 further includes a transmitter circuit 210. The transmitter circuit 210 is coupled to the transmitter power source 202 via a transformer 218, which adjusts the voltage from the power source 202 to a voltage usable by the transmitter circuit 210. The transmitter circuit 210 is coupled to the transmitter audio connector port 204 and to a wireless transmitter antenna 212 and converts an audio input signal received from the transmitter audio connector port 204 into a wireless (e.g. radio frequency) signal for transmission by the wireless transmitter antenna 212. The wireless transmitter antenna 212 transmits the signal for receipt by the wireless receiver antenna 118 of the audio enhancement device 100 which in turn processes and amplifies the signal as discussed in greater detail below. As such, the wireless receiver antenna 118 will be tuned to the frequency on which the wireless transmitter antenna 212 transmits. Suitable designs for the transmitter circuit 210 will be apparent to one skilled in the art, now informed by the herein disclosure. The term “circuit”, as used herein, includes conventional circuits, integrated circuit chips and programmable devices.

In embodiments where the device power source 102 of the audio enhancement device 100 is a rechargeable battery, the transmitter station 200 also has one or more docking ports 214 for receiving one or more respective personal audio enhancement devices 100. In the exemplary embodiment shown in the Figures, the transmitter station 200 has two docking ports 214. The docking ports 214 expose power supply terminals 216 that are coupled to the transmitter power source 202 via the transformer 218. These power supply terminals 216 align with the recharging terminals 132 of the audio enhancement device 100 when the personal audio enhancement device 100 is received in the docking port 214. Since the recharging terminals 132 of the audio enhancement device 100 are coupled to the device power source 102, the device power source 102 can recharge from the transmitter power source 202 when the personal audio enhancement device 100 is received in the docking port 214. Thus, the transmitter station 200 can transmit wireless audio signals to the audio enhancement device 100 and can also charge the personal audio enhancement device 100. Effectively, the transmitter station 200 operates as a charging and transmitting base for the audio enhancement device 100.

As noted above, in addition to the wireless receiver antenna 118 for receiving signals from the wireless transmitter antenna 212 of the transmitter station 200, the audio enhancement device 100 has two bidirectional audio connector ports 106 and 112. The first bidirectional audio connector port 106 has an input channel 108 and an output channel 110, and the second bidirectional audio connector port 112 has an input channel 114 and an output channel 116. Thus, signals can be received by the signal processor 104 from the wireless receiver antenna 118 and also from each of the input channels 108, 114. Once a signal is received, it is processed by the signal processor 104. The signal processor 104 includes a frequency-selective amplifier 120 which selectively amplifies frequencies from the input signal. Once the appropriate frequencies are amplified, the signal processor 104 transmits the amplified signals to one of the output channels 110 or 116, to which a headset or other device may be connected to enable the user to listen to the amplified signals. The signal processor and the frequency-selective amplifier 120 may be implemented entirely in hardware, entirely in software, or in a combination of hardware and software. In one preferred embodiment, the frequency-selective amplifier 120 is implemented in accordance with U.S. Pat. No. 7,149,320, the teachings of which are hereby incorporated by reference.

The personal audio enhancement device 100 includes a control interface 122 that permits selection among different modes depending on the audio signals requiring processing. The control interface enables selection among a wireless signal mode (selection box 124), ambient mode (selection box 126), interconnect mode (selection box 128), and predefined audio mode (selection box 130). Each mode is described below. The control interface 122 may be, for example, a multi-position physical switch, a touch-screen, or any other suitable interface.

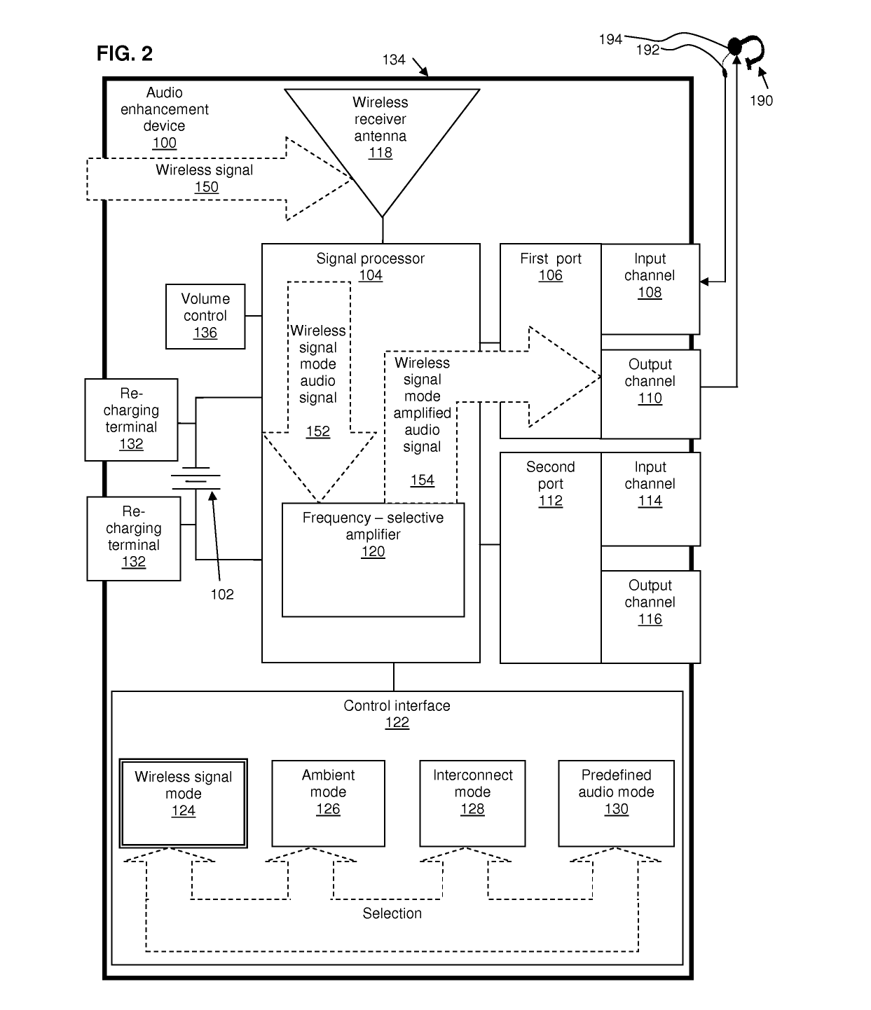

FIG. 2 is a schematic representation of signal processing by a personal audio enhancement device 100 in which the exemplary wireless signal mode has been selected, as shown by the emphasized selection box 124. When the personal audio enhancement device 100 is in the wireless signal mode, the wireless receiver antenna 118 receives a wireless signal 150 from the wireless transmitter antenna 212 of the transmitter station 200 (FIG. 1). Upon receipt of the wireless signal 150, the signal processor 104 converts the wireless signal 150 to a wireless signal mode audio signal 152. The frequency-selective amplifier 120 then amplifies selected frequencies of the wireless signal mode audio signal 152 to obtain a wireless signal mode amplified audio signal 154. The signal processor 104 then delivers the wireless signal mode amplified audio signal 154 to the audio output channel 110 of the first bidirectional audio connector port 106. Where an earphone (or some other speaker system) is connected to the first port 106, and in particular to the audio output channel 110 thereof, the user will hear sounds derived from the wireless signal mode amplified audio signal 154. Preferably, the earphones are part of a wired hands-free telephone unit 190 comprising a microphone 192 and one or more earphones 194, such as that used for wired hands-free operation of a mobile phone.

The wireless signal 150 will be derived from the output of whatever external audio device 208 is connected to the transmitter station 200 via the external device audio connector port 206 and the transmitter audio connector port 204, and will be transmitted by the wireless transmitter antenna 212 of the transmitter station 200. Preferably, the wireless signal is a radio frequency signal. Where a radio frequency signal is used, a clear line-of-sight is not required between the wireless transmitter antenna 212 and the receiver antenna 118 of the audio enhancement device 100. Additionally, a radio frequency wireless signal 150 can be received by more than one personal audio enhancement device 100. This one-to-many linking permits several users, each with their own personal audio enhancement device 100, to enjoy together the same audio source. The volume control 136 of each personal audio enhancement device 100 allows for each listener to adjust the volume level according to his or her individual preference. A transmitter station such as the transmitter station 200 is not limited to residential applications, and could be deployed, for example, in a theatre to broadcast a wireless signal 150 to any personal audio enhancement devices 100 located in the theatre.

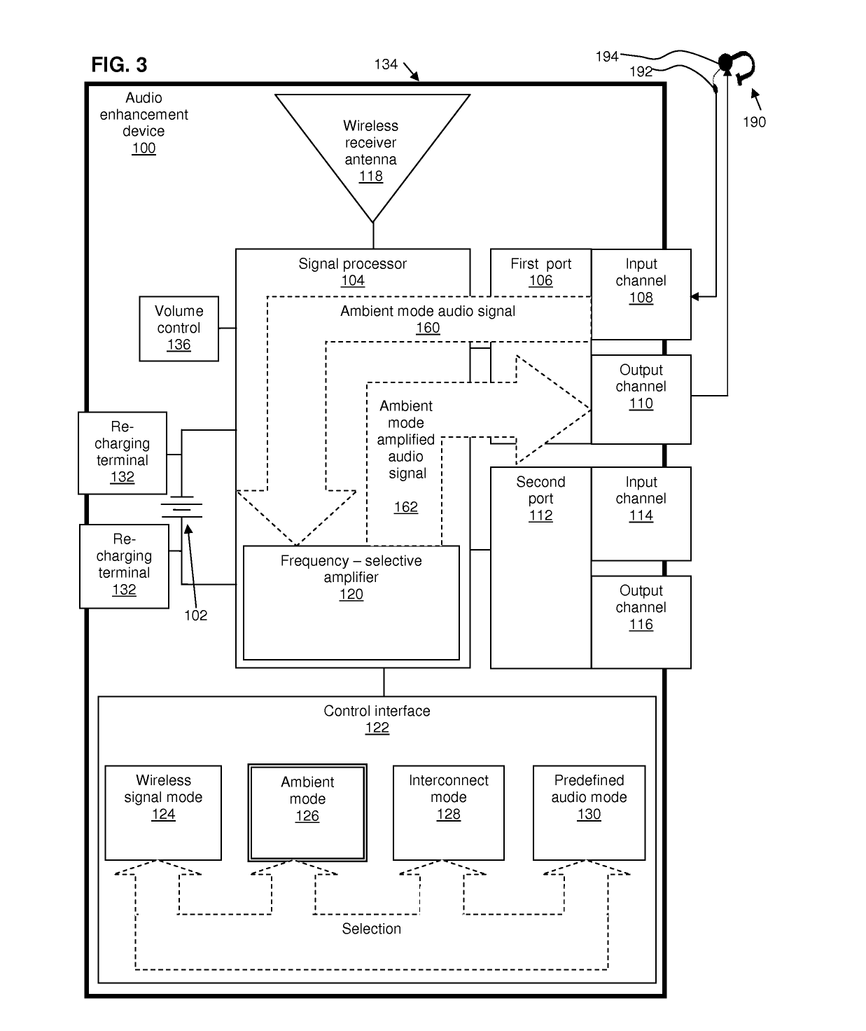

FIG. 3 is a schematic representation of signal processing by a personal audio enhancement device 100 in which the exemplary ambient mode has been selected, as shown by the emphasized selection box 126. In the ambient mode, the personal audio enhancement device 100 amplifies selected ambient sounds in social settings such as at restaurants, busy streets, group meetings, and casual conversation. When the personal audio enhancement device 100 is in the ambient mode, a user would connect a wired microphone and earphone set, such as wired hands-free telephone unit 190, to the first bidirectional audio connector port 106, with the microphone output connected to the input channel 108 and the speaker input connected to the output channel 110. Thus, the signal processor 104 receives sound from the microphone through the input channel 108 of the first bidirectional audio connector port 106 as an ambient mode audio signal 160. The frequency-selective amplifier 120 then amplifies selected frequencies of the ambient mode audio signal 160 to create an ambient mode amplified audio signal 162 which the signal processor 104 then sends to the output channel 110 of the first bidirectional audio connector port 106 for delivery to the earphone 194. By selectively amplifying certain frequencies, the audio enhancement device 100 reduces the impact of background noise to make understanding speech easier for the user when communicating in noisy surroundings.

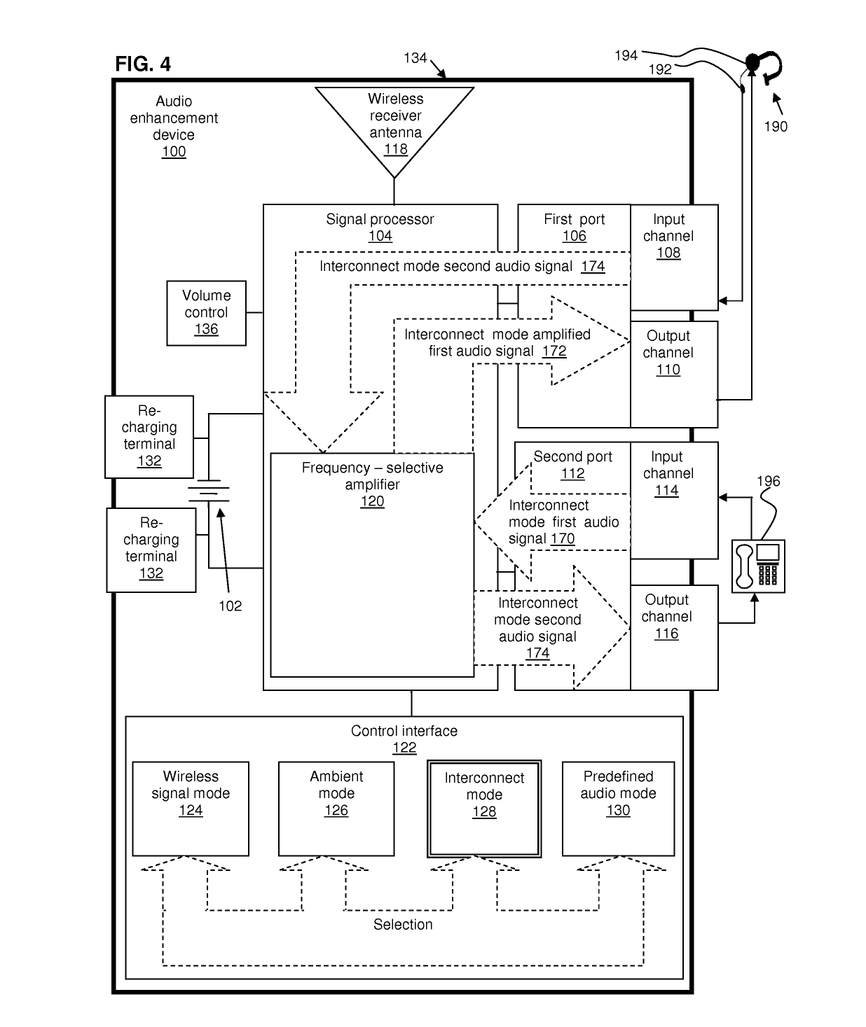

FIG. 4 is a schematic representation of signal processing by a personal audio enhancement device 100 in which the exemplary interconnect mode has been selected, as shown by the emphasized selection box 128. In the interconnect mode, the audio enhancement device 100 can enhance the listener's experience during phone conversations. When the personal audio enhancement device 100 is in the interconnect mode, a user would connect a wired microphone and earphone set, such as wired hands-free telephone unit 190, to the first bidirectional audio connector port 106, with the microphone 192 connected to the input channel 108 and the earphone 194 connected to the output channel 110, and would connect a telephone 196 to the second bidirectional audio connector port 112. For example, in a preferred embodiment a user would connect a wire with suitable standard audio plugs at each end to an audio socket on the telephone 196 and to the second bidirectional audio connector port 112. The audio output from the telephone 196 would be coupled to the input channel 114 of the second bidirectional audio connector port 112 and the audio input to the telephone 196 would be coupled to the output channel 116 of the second bidirectional audio connector port 112. The telephone 196 may be, for example, a conventional landline telephone, a mobile radio telephone or an Internet phone using Voice over Internet Protocol (VoIP).

During a telephone call, when the telephone 196 generates audio output the signal processor 104 will receive an interconnect mode first audio signal 170 from the input channel 114 of the second bidirectional audio connector port 112. The frequency-selective amplifier 120 then selectively amplifies the interconnect mode first audio signal 170 to obtain an interconnect mode amplified first audio signal 172 which the signal processor 104 then sends to the output channel 110 of the first bidirectional audio connector 106 for delivery to the earphone 194. When the user of the audio enhancement device 100 speaks, the microphone 192 generates an interconnect mode second audio signal 174, which is delivered by the input channel 108 of the first bidirectional audio connector port 106 to the signal processor 104. The signal processor 104 passes the interconnect mode second audio signal 174, with or without amplification by the frequency-selective amplifier 120, to the output channel 116 of the second bidirectional audio connector port 112 for delivery to the telephone 196. The interconnect mode can also be used to receive audio signals from a device other than a telephone. For example, a wired connection can be made between an audio output socket on a television, personal entertainment device or other device and the second bidirectional audio connector port 112 on the personal audio enhancement device 100.

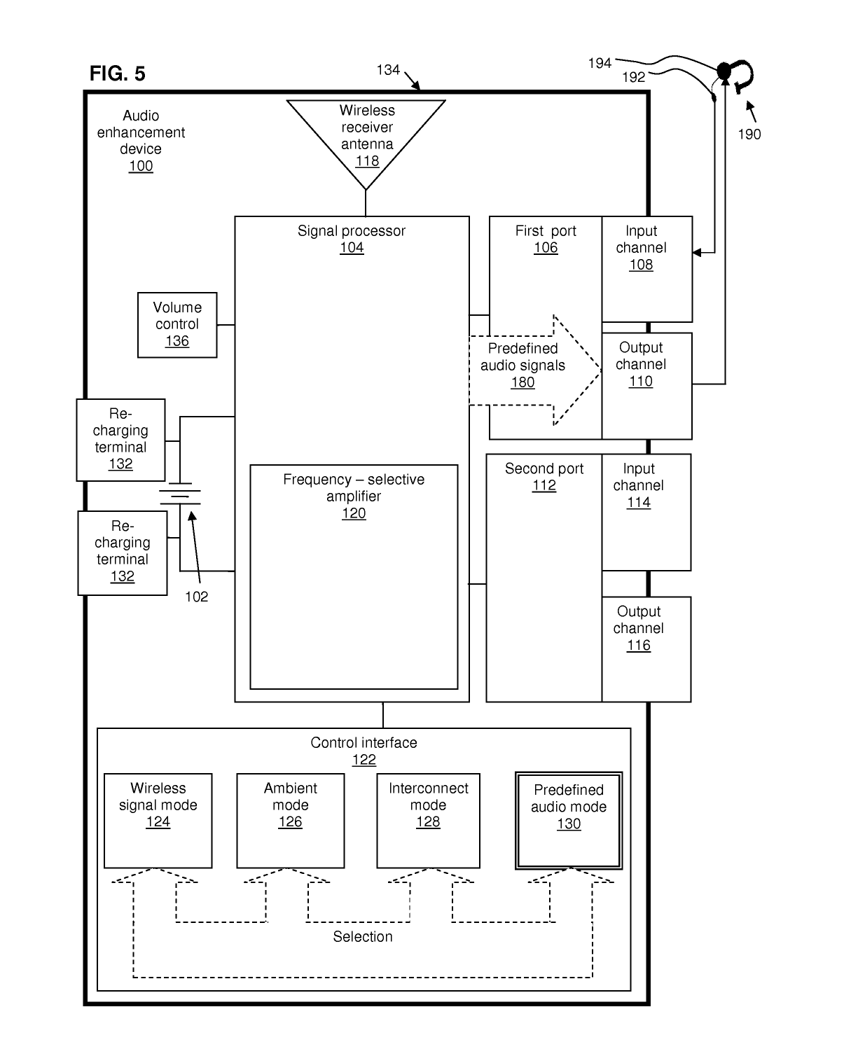

FIG. 5 is a schematic representation of signal processing by a personal audio enhancement device 100 in which the exemplary predefined audio mode has been selected, as shown by the emphasized selection box 130. In the predefined audio mode, the audio enhancement device 100 delivers predefined audio signals, for example music, sounds from nature or sounds designed for relaxation, meditation, or sleep. Thus, predefined audio signals 180 are provided by the signal processor 104, for example by retrieval from storage in memory or by applying a predefined sound generation algorithm, and sent to the output channel 110 of the first bidirectional audio connector port 106 for delivery to the earphone 194 and enjoyment by the user.

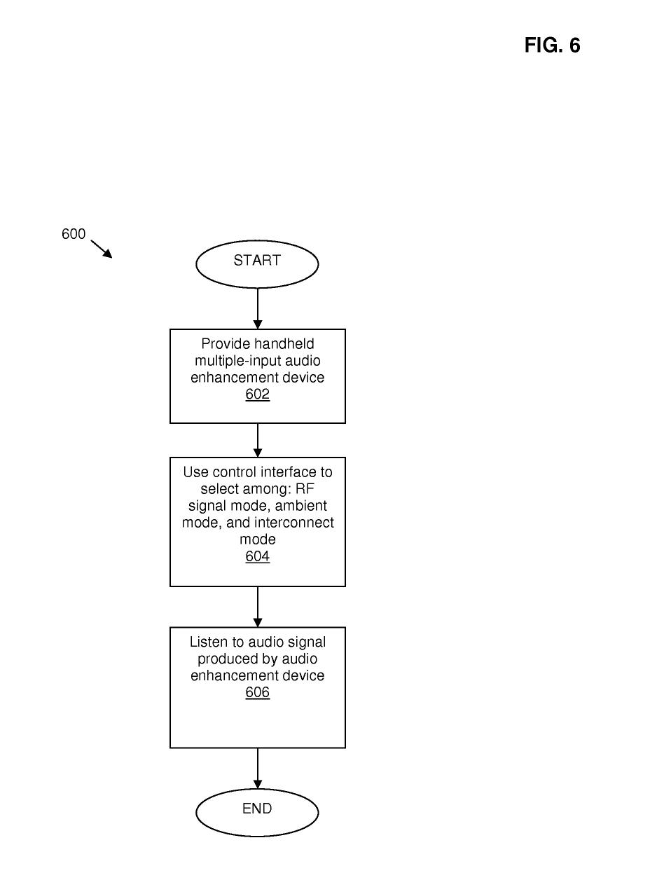

Referring now to FIG. 6, a method 600 of using a handheld multiple-input personal audio enhancement device will now be described. At step 602, a handheld multiple-input audio enhancement device, such as the exemplary personal audio enhancement device 100 described above, is provided. Accordingly, at step 604, the control interface is used to select among at least a wireless signal mode, an ambient mode, and an interconnect mode, and at step 606, the listener listens to the audio signal produced by the audio enhancement device.

If the wireless signal mode is selected at step 604, the signal processor converts a wireless signal received by the wireless receiver antenna into a wireless signal mode audio signal, amplifies selected frequencies of the wireless signal audio signal to obtain a wireless signal mode amplified audio signal, and delivers the wireless signal mode amplified audio signal to an audio output channel of the first bidirectional audio connector port.

If the ambient mode is selected at step 604, the signal processor receives an ambient mode audio signal from an audio input channel of the first bidirectional audio connector port, amplifies selected frequencies of the ambient mode audio signal to obtain an ambient mode amplified audio signal, and delivers the ambient mode amplified audio signal to the audio output channel of the first bidirectional audio connector port.

If the interconnect mode is selected at step 604, the signal processor receives an interconnect mode first audio signal from an audio input channel of the second bidirectional audio connector port, amplifies selected frequencies of the interconnect mode first audio signal to obtain an interconnect mode amplified audio signal, and delivers the interconnect mode amplified audio signal to the audio output channel of the first bidirectional audio connector port. The signal processor also receives an interconnect mode second audio signal from an audio input channel of the first bidirectional audio connector port and delivers the interconnect mode second audio signal to the audio output channel of the second bidirectional audio connector port.

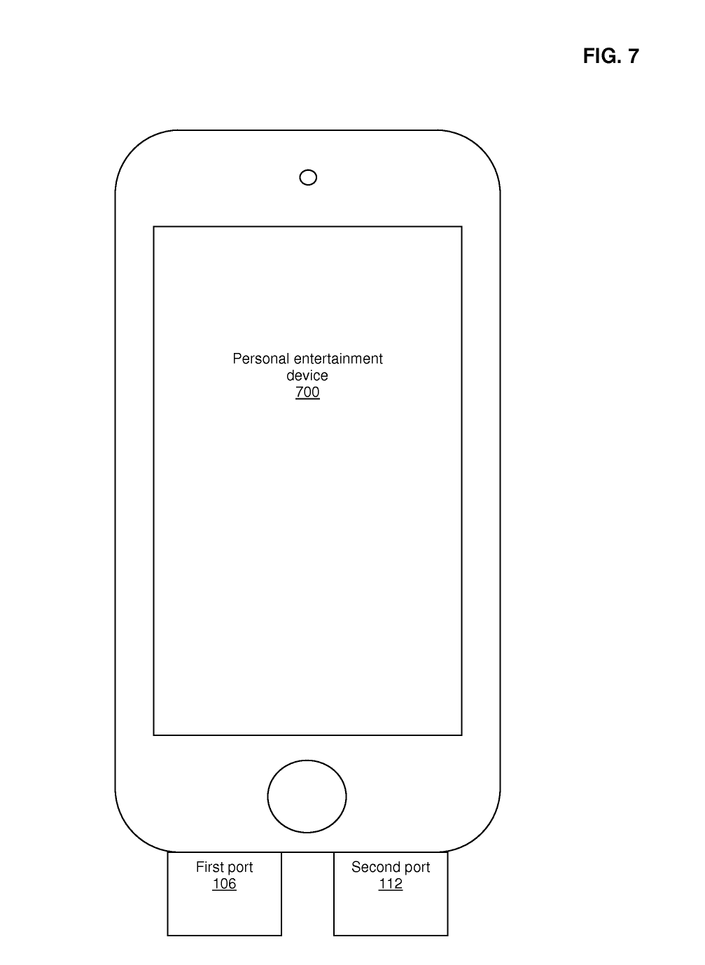

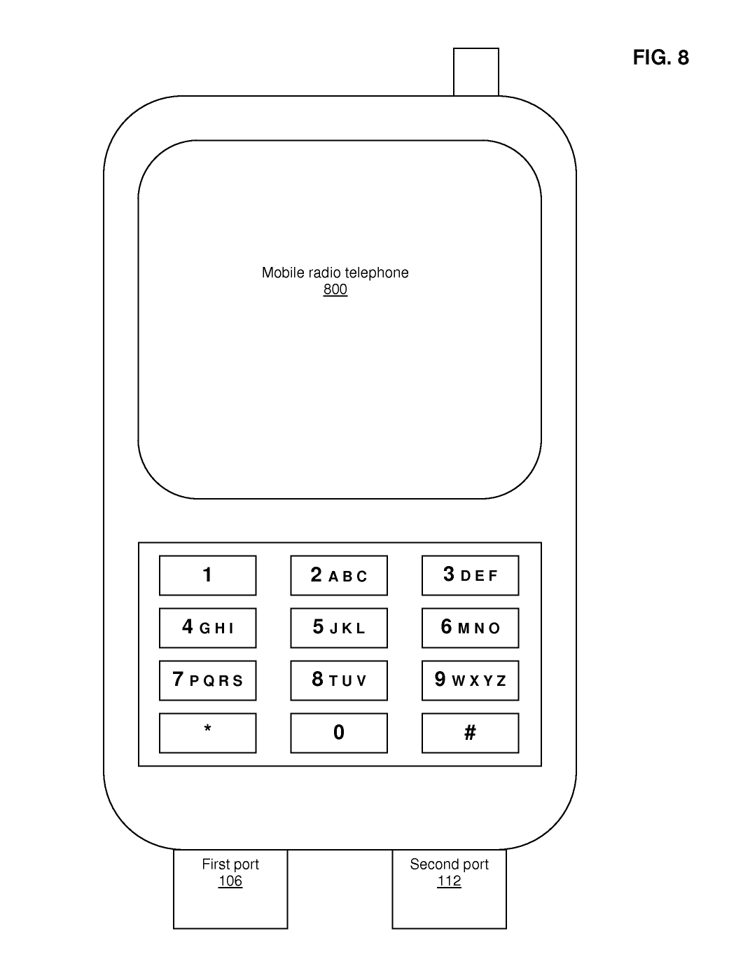

In some embodiments, the personal audio enhancement device 100 can form part of a personal entertainment device such as a handheld video game system or music player, or may form part of a mobile radio telephone. FIG. 7 shows a personal entertainment device 700 which includes a personal audio enhancement device of the type described herein, and FIG. 8 shows a mobile radio telephone 800 which includes a personal audio enhancement device of the type described herein, as can be seen in each case from the exposed first and second bidirectional audio connector ports 106 and 112. The signal processor of the personal audio enhancement device may be integrated with the hardware and/or software of the personal entertainment device 700 or mobile radio telephone 800, and may take the form of software executing in a general purpose processor.

Some embodiments of a personal audio enhancement device may not include a wireless receiver antenna or corresponding wireless audio mode, and some embodiments may not include a predefined audio mode.

One or more currently preferred embodiments have been described by way of example. It will be apparent to persons skilled in the art that a number of variations and modifications can be made without departing from the scope of the appended claims.

What is claimed is:

1. A handheld multiple-input personal audio enhancement device, comprising:
a device power source;
a signal processor coupled to the device power source;
a first bidirectional audio connector port coupled to the signal processor; and
a second bidirectional audio connector port coupled to the signal processor.

2. The personal audio enhancement device of claim 1, further comprising a wireless receiver antenna coupled to the signal processor for receiving wireless signals.

3. The personal audio enhancement device of claim 2, wherein the signal processor includes a frequency-selective amplifier.

4. The personal audio enhancement device of claim 3, wherein the personal audio enhancement device comprises a control interface coupled to the signal processor for selecting among a plurality of audio modes.

5. The personal audio enhancement device of claim 4, wherein the control interface enables selection among:
a wireless signal mode in which the signal processor converts a wireless signal received by the wireless receiver antenna into a wireless signal mode audio signal, amplifies selected frequencies of the wireless signal mode audio signal to obtain a wireless signal mode amplified audio signal, and delivers the wireless signal mode amplified audio signal to an audio output channel of the first bidirectional audio connector port;
an ambient mode in which the signal processor receives an ambient mode audio signal from an audio input channel of the first bidirectional audio connector port, amplifies selected frequencies of the ambient mode audio signal to obtain an ambient mode amplified audio signal, and delivers the ambient mode amplified audio signal to the audio output channel of the first bidirectional audio connector port; and
an interconnect mode in which the signal processor receives an interconnect mode first audio signal from an audio input channel of the second bidirectional audio connector port, amplifies selected frequencies of the interconnect mode first audio signal to obtain an interconnect mode first amplified audio signal, and delivers the interconnect mode first amplified audio signal to the audio output channel of the first bidirectional audio connector port.

6. The personal audio enhancement device of claim 5, wherein in the interconnect mode, the signal processor receives an interconnect mode second audio signal from the audio input channel of the first bidirectional audio connector port and delivers the interconnect mode second audio signal to an audio output channel of the second bidirectional audio connector port.

7. The personal audio enhancement device of claim 6, wherein the control interface enables selection among the wireless signal mode, the ambient mode, the interconnect mode and a predefined audio mode in which the signal processor delivers predefined audio signals to the audio output channel of the first bidirectional audio connector port.

8. A personal audio enhancement system, comprising:
the audio enhancement device of claim 6; and
a transmitter station, the transmitter station comprising:
a transmitter power source;
a transmitter audio connector port for receiving at least an audio input signal;
a wireless transmitter antenna; and
a transmitter circuit coupled to the power source, the transmitter audio connector port and the wireless transmitter antenna for converting the audio input signal to a wireless signal and delivering the wireless signal to the antenna for broadcast on a frequency to which the wireless receiver antenna is tuned.

9. The personal audio enhancement system of claim 8, wherein:
the device power source is at least one rechargeable battery and the personal audio enhancement device exposes recharging terminals coupled to the at least one rechargeable battery for recharging the at least one rechargeable battery;
the transmitter station includes at least one docking port for receiving the audio enhancement device;
each docking port exposing power supply terminals aligned with the recharging terminals when the audio enhancement device is received at the docking port; and
the power supply terminals being coupled to the transmitter power source.

10. The personal audio enhancement system of claim 9, wherein the at least one docking port comprises two docking ports.

11. The personal audio enhancement device of claim 1, wherein the personal audio enhancement device forms part of a personal entertainment device.

12. The personal audio enhancement device of claim 1, wherein the personal audio enhancement device forms part of a mobile radio telephone.

13. The personal audio enhancement device of claim 1, further comprising a housing carrying the device power source, the signal processor, the first bidirectional audio connector port and the second bidirectional audio connector port with the first bidirectional audio connector port and the second bidirectional audio connector port being exposed to receive respective connectors.

14. The audio enhancement device of claim 13, wherein the housing has dimensions smaller than 200 millimeters long by 120 millimeters wide by 40 millimeters thick.

15. The audio enhancement device of claim 14, wherein the housing has dimensions smaller than 150 millimeters long by 90 millimeters wide by 30 millimeters thick.

16. The audio enhancement device of claim 15, wherein the housing has dimensions smaller than 120 millimeters long by 72 millimeters wide by 24 millimeters thick.

17. A kit of parts, comprising:
the audio enhancement device of claim 1; and
a housing for carrying the device power source, the signal processor, the first bidirectional audio connector port and the second bidirectional audio connector port with the first bidirectional audio connector port and the second bidirectional audio connector port being exposed to receive respective connectors.

18. A method of using a handheld multiple-input personal audio enhancement device, the method comprising the steps of:
providing a handheld multiple-input audio enhancement device comprising:
a device power source;
a signal processor coupled to the power source;
a first bidirectional audio connector port coupled to the signal processor;
a second bidirectional audio connector port coupled to the signal processor;
a wireless receiver antenna coupled to the signal processor for receiving wireless signals; and
a control interface coupled to the signal processor for selecting among a plurality of audio modes; and
using the control interface to select among:
a wireless signal mode in which the signal processor converts a wireless signal received by the wireless receiver antenna into a wireless signal mode audio signal, amplifies selected frequencies of the wireless signal audio signal to obtain a wireless signal mode amplified audio signal, and delivers the wireless signal amplified audio signal to an audio output channel of the first bidirectional audio connector port;
an ambient mode in which the signal processor receives an ambient mode audio signal from an audio input channel of the first bidirectional audio connector port, amplifies selected frequencies of the ambient mode audio signal to obtain an ambient mode amplified audio signal, and delivers the ambient mode amplified audio signal to the audio output channel of the first bidirectional audio connector port; and
an interconnect mode in which the signal processor receives an interconnect mode first audio signal from an audio input channel of the second bidirectional audio connector port, amplifies selected frequencies of the interconnect mode first audio signal to obtain an interconnect mode amplified audio signal, and delivers the interconnect mode amplified audio signal to the audio output channel of the first bidirectional audio connector port.

19. The method of claim 18, wherein using the control interface to select among the wireless signal mode, the ambient mode and the interconnect mode comprises using the control interface to select among the wireless signal mode, the ambient mode, the interconnect mode and a predefined audio mode in which the signal processor delivers predefined audio signals to the audio output channel of the first bidirectional audio connector port.
